(19) United States
(12) Patent Application Publication
(10) Pub. No.: US 2002/0027534 A1
(43) Pub. Date: Mar. 7, 2002

(54) Three dimensional image viewer

(76) Inventor: Anthony Lo, Hong Kong (HK)

Correspondence Address: Finnegan, Henderson, Farabow,, Garrett & Dunner, L.L.P., 1300 I Street, N.W., Washington, DC, 20005-3315, US

(21) Appl. No.: 09/933,040

(22) Filed: Aug. 21, 2001

(30) Foreign Application Priority Data
Aug. 25, 2000 (GB) 0020866.0

(51) Int. Cl. G09G 5/00

(52) U.S. Cl. 345/5

(57) ABSTRACT

A system and method for viewing a three-dimensional (3D) photograph is provided. The three-dimensional (3D) image viewer includes a base. A print holder is attached to the base and is configured to hold a print containing a right image and a left image. A housing is disposed on the base and includes a right viewing port and a left viewing port. A beam-splitter is disposed on the base between the print holder and the right and left viewing ports. The beam-splitter is configured to project a representation of the right image in the left viewing port and a representation of the left image in the right viewing port.

### DESCRIPTION OF THE INVENTION

1. Field of the Invention

This invention relates to a three dimensional (3D) viewer for viewing 3D photographic prints.

2. Background of the Invention

The popularity of three-dimensional, or stereo, photography is increasing along with technology advances in the filed. Stereo photography allows a user to take a stereo photograph of a subject. When the stereo photograph is viewed through an appropriate viewer, the user is presented with a three-dimensional image of the subject, as opposed to a two-dimensional image as would be obtained with a standard camera.

A stereo photograph includes two images of the same subject captured on the same exposure of film. The stereo camera is configured to project the two images onto the exposure of film at slightly different angles. When the film is developed, the resulting print will include dual images of the subject that are slightly offset from each other.

It is known that, before the stereo print can be properly viewed with a conventional viewer, the pair of images will have to be transposed and aligned. This is typically accomplished by physically separating the two images and manually aligning the images in a stereo viewer for viewing. This preparation process can be a time-consuming and tedious process. In addition, if the process is not performed properly, the stereo photograph may be rendered unviewable.

In light of the foregoing, there is a need for a three-dimensional viewer that solves one or more of the problems identified above.

### SUMMARY OF THE INVENTION

Accordingly, the present invention is directed to an improved three-dimensional image viewer that obviates one or more of the limitations and disadvantages of the prior art image viewers. The advantages and purposes of the invention will be set forth in part in the description which follows, and in part will be obvious from the description, or may be learned by practice of the invention. The advantages and purposes of the invention will be realized and attained by the elements and combinations particularly pointed out in the appended claims.

To attain the advantages and in accordance with the purposes of the invention, as embodied and broadly described herein, the invention is directed to a three-dimensional (3D) image viewer that includes a base. A print holder is attached to the base and is configured to hold a print containing a right image and a left image. A housing is disposed on the base and includes a right viewing port and a left viewing port. A beam-splitter is disposed on the base between the print holder and the right and left viewing ports. The beam-splitter is configured to project a representation of the right image in the left viewing port and a representation of the left image in the right viewing port.

In another aspect, the present invention is directed to a three-dimensional (3D) image viewer that includes a base. An LCD screen display is attached to the base and is operable to display a right image of a subject and left image of the subject. A housing is disposed on the base and includes a right viewing port and a left viewing port. A beam-splitter is disposed on the base between the print holder and the right and left viewing ports. The beam-splitter is configured to project a representation of the right image in the left viewing port and a representation of the left image in the right viewing port.

Yet another aspect of the present invention is directed to a method of viewing a three-dimensional (3D) photographic print. A 3D photographic print having a right two-dimensional image of a subject and a left two-dimensional image of the subject is provided. A representation of the left two-dimensional image is projected through a right viewing port. A representation of the right two-dimensional image is projected through a left viewing port.

In still another aspect, the present invention is directed to a three-dimensional (3D) image viewer that includes a base. A housing is disposed on the base and includes a right viewing port and a left viewing port. A print holder is attached to the base and is configured to hold a print containing a right image and a left image such that one of the left and right images is viewable through the right viewing port and the other of the left and right images is viewable through the left viewing port. The print holder includes a first trackway configured to receive a first side of the print adjacent the right image and a second trackway configured to receive a second side of the print adjacent to the left image.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1A is a schematic representation of a stereo camera, illustrating the exposure of a three-dimensional photograph;

FIG. 1B is a schematic representation of a conventional three-dimensional photograph viewer;

FIG. 2 is a top view of a three-dimensional image viewer in accordance with an embodiment of the present invention;

FIG. 3 is a side view of the three-dimensional image viewer of FIG. 2;

FIG. 4 is an end view of the three-dimensional image viewer of FIG. 1

FIG. 5 is a top view of a three-dimensional image viewer having a light source in accordance with an embodiment of the present invention; and

FIG. 6 is a side view of the three-dimensional image viewer of FIG. 5.

### DESCRIPTION OF THE EMBODIMENTS

Reference will now be made in detail to the present embodiment and exemplary embodiments of the invention, an example of which is illustrated in the accompanying drawings. Wherever possible, the same reference numbers will be used throughout the drawings to refer to the same or like parts.

In accordance with the present invention, a three-dimensional (3D) image viewer is provided. The 3D image viewer may be used to view stereo photographs. The stereo photographs may be created with any conventional stereo camera that places dual images of a photographic subject onto a single exposure of film.

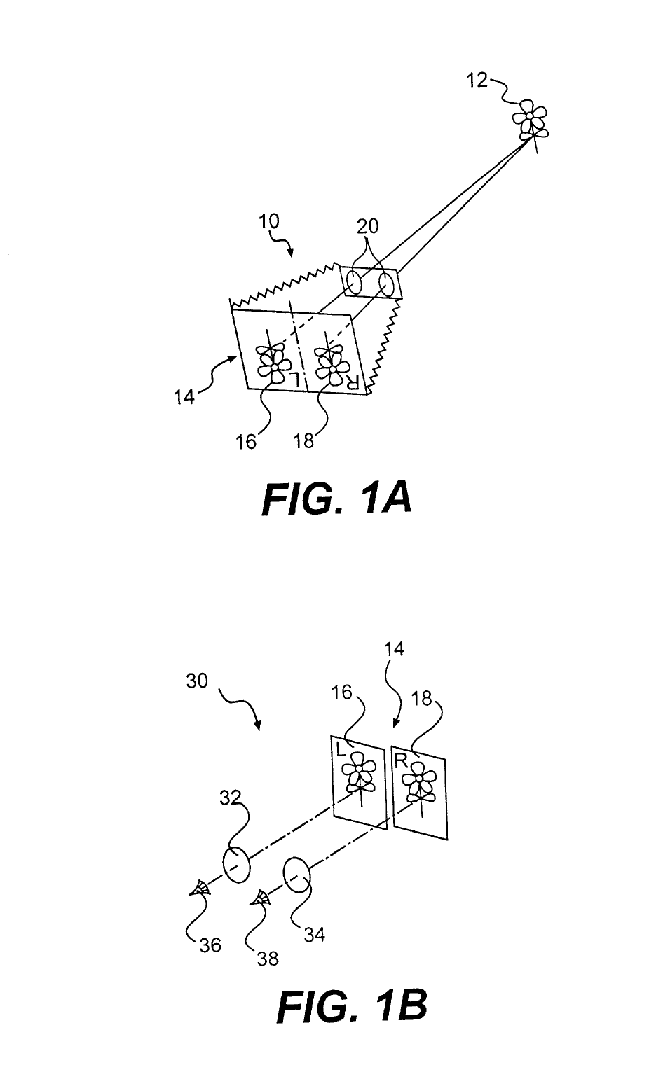

As illustrated in FIG. 1A, a stereo camera includes a pair of lenses 20. Lenses 20 are configured to project dual images of a subject 12 onto a single exposure of film 14. As is known in the art, each of the lenses 20 will project an inverted representation of subject 12 onto film exposure 14. Thus, film exposure 14 will capture a left image 16 of subject 12 and a right image 18 of subject 12. The right and left images 16, 18 will be inverted as illustrated in FIG. 1A.

As shown in FIG. 1B, a conventional three-dimensional photograph viewer 30 will typically include a left lens 32 and a right lens 34. Before the three-dimensional photograph may be positioned in viewer 30, left image 16 and right image 18 must be independently rotated 180°. This is typically accomplished by physically separating the two images, such as by cutting. After left image 16 and right image 18 are separated, they may be rotated and positioned in front of left lens 32 and right lens 34. Now, when a user views the three-dimensional photograph, a representation of left image 16 will be presented to the users left eye 36 and a representation of right image 18 will be presented to the user's right eye 38. The combination of images will result in the user seeing a three-dimensional image of subject 12.

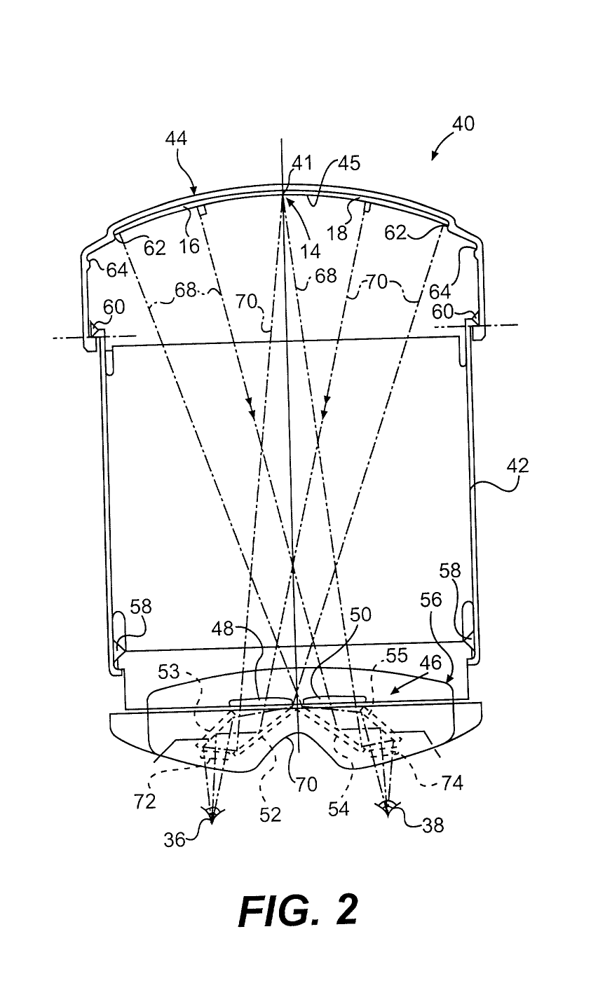

The present invention provides a three-dimensional image viewer that obviates the need to separate and rotate the left and right images of a stereo photograph. As described in greater detail below, the three-dimensional image viewer of the present invention includes a beam-splitter that transposes the images. An exemplary embodiment of a three-dimensional image viewer according to the present invention is illustrated in FIG. 2 and is designated generally by the reference numeral 40.

As illustrated in FIG. 2, a three-dimensional image viewer 40 includes a base 42. A print holder 44 is disposed at one end of base 42 and a housing 56 is disposed at the opposite end of base 42. A beam splitter 46 is also disposed on base 42.

Print holder 44 is configured to receive and hold a stereo photograph 14. Stereo photograph 14 has a left image 16 of a subject and a right image 18 of the same subject. For the purposes of the present disclosure, the phrases “left” and “right” are intended to refer to the respective portions of the stereo photograph when viewed in a conventional manner.

As illustrated, print holder 44 has a wall 45 with a concave shape. When stereo photograph 14 is inserted into print holder 44, stereo photograph 14 will try to straighten and spring away from wall 45. A pair of lips 62 may be disposed at either end of print holder 44. Lips 62 define a slot, or trackway, that prevents the stereo photograph 14 from springing away from wall 45. Thus, the present invention may not require a central constraint to secure the photograph as has often been required. In this regard, the photograph may be more readily inserted and removed. In addition, as described in greater detail below, lips 62 position stereo photograph 14 with respect to beam-splitter 46 for proper viewing.

A second set of lips 64 may also be disposed at either end of wall 45. Second set of lips 64 also define a slot, or trackway. The second slot is configured to receive a stereo photograph 14 that is larger than the stereo photograph receivable in the first slot defined by lips 62. The second slot will hold the larger stereo photograph in position for proper viewing.

If so desired, the stereo photograph 14 may be bent to form a joint 41 between the left image 16 and the right image 18. In this embodiment, wall 45 of print holder 44 may include two flat sections joined at an angle corresponding to the bend in stereo photograph 14. Wall 45 will position left image 16 and right image 18 within viewer 40 for proper viewing.

The present invention contemplates that a Liquid Crystal Display (LCD) screen may be used instead of a print holder and a traditional stereo photograph. The LCD screen may display digital images, such as produced by a common digital camera. A single LCD screen may be configured to display the left and right images. Alternatively two separate LCD screens may be included. The first LCD screen may display the left image and the second LCD screen may display the right image.

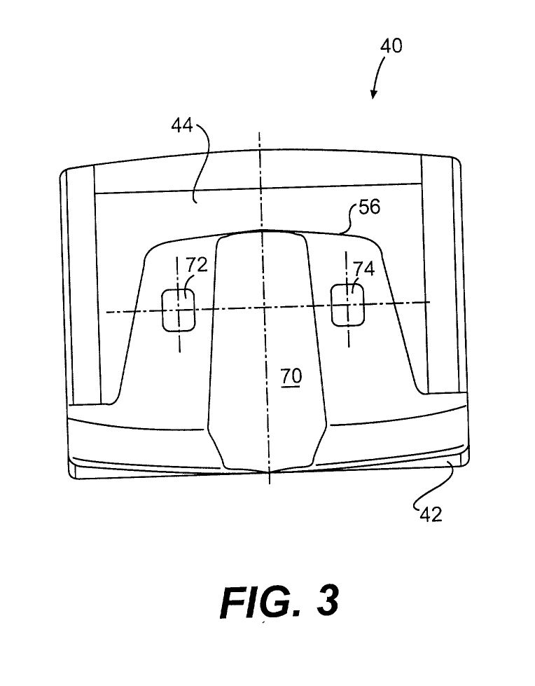

As illustrated in FIG. 3, housing 56 includes a left viewing port 72 and a right viewing port 74. A nose piece 70 is disposed between the left and right viewing ports 72, 74. Housing 56 is configured to allow a user to position their left eye 36 (referring to FIG. 2) adjacent left viewing port 74 and their right eye 38 (referring to FIG. 2) adjacent right viewing port 74.

As illustrated in FIG. 2, beam-splitter 46 is positioned between print holder 44 and left and right viewing ports 72, 74. Beam-splitter 46 includes a left set of mirrors 52, 53 and a right set of mirrors 54, 55. Left set of mirrors 52, 53 is configured to direct light rays 70 emanating from right image 18 through left viewing port 72. Right set of mirrors 54, 55 is configured to direct light rays 68 emanating from left image 16 through right viewing port 74.

The light rays 68 intended for the user's right eye 38 emanate from the center of left image 16 at a right angle to the left image 16. These light rays 68 strike on first mirror 54 and reflect towards second mirror 55. Second mirror 55 directs light rays 68 through right viewing port 74 towards the observer's right eye 38.

The light rays 70 intended for the user's left eye 36 emanate from the center of right image 18 at a right angle to the right image 18. These light rays 70 strike on first mirror 52 and reflect towards second mirror 53. Second mirror 53 directs light rays 50 through left viewing port 72 towards the observer's left eye 36.

Thus, when a user places viewer 44 to their eyes, a representation of left image 16 will be projected through right viewing port 74 and a representation of right image 18 will be projected through left viewing port 72. For greater comfort and ease of fusion of the 3D images, the rays leaving mirrors 53, 55 may be slightly diverging. This will force the user's eyes to converge slightly to view them. Since the images being viewed are at right angles to the principal ray (which may also be referred to as the centerline of sight shown with a two headed arrow in FIG. 2), there is no distortion of the images when viewed by the user.

A pair of magnifying lenses 48, 50 may be disposed between beam splitter 46 and print holder 44. One magnifying lens 48 may be associated with left set of mirrors 52, 53 and the other magnifying lens 59 may be associated with right set of mirrors 54, 55. Alternatively, magnifying lenses 48, 50 may be disposed at or adjacent to left and right viewing ports 72, 74. The relative position of magnifying lenses 48, 50 will impact the size of the three-dimensional image viewed through viewing ports 72, 74.

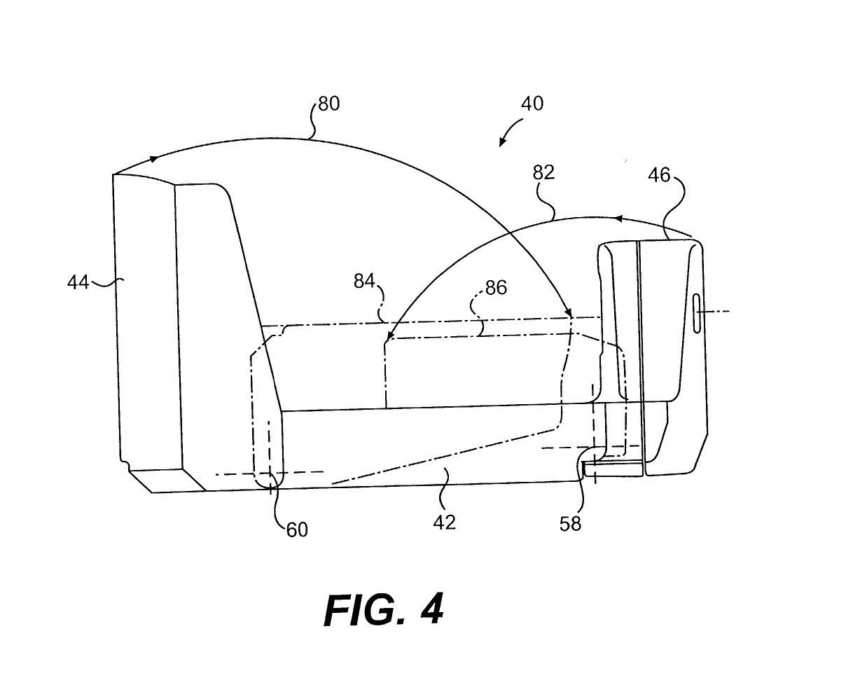

As illustrated in FIG. 4, print holder 44 and housing 46 may be pivotally disposed on base 42. Print holder 44 pivots about axis 60 and housing 46 pivots about axis 58. Print holder 44 may be rotated as indicated by arrow 80 into a folded position (as indicated by dashed line 84). Housing 46 may be rotated as indicated by arrow 82 into a folded position (as indicated by dashed line 86). In this manner, viewer 40 may be folded into a compact unit for ease of transport and to protect the internal components.

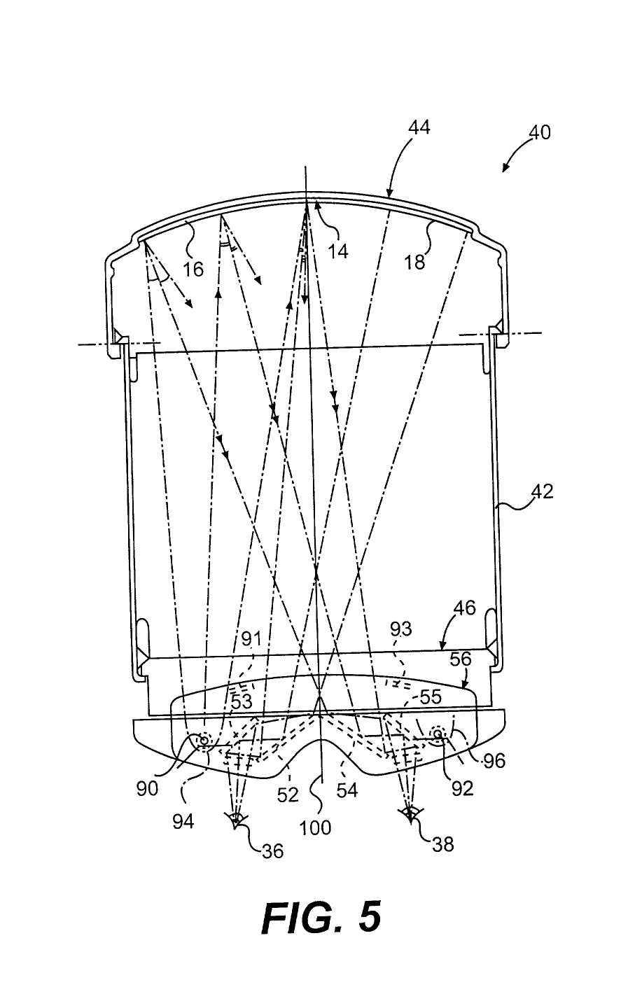

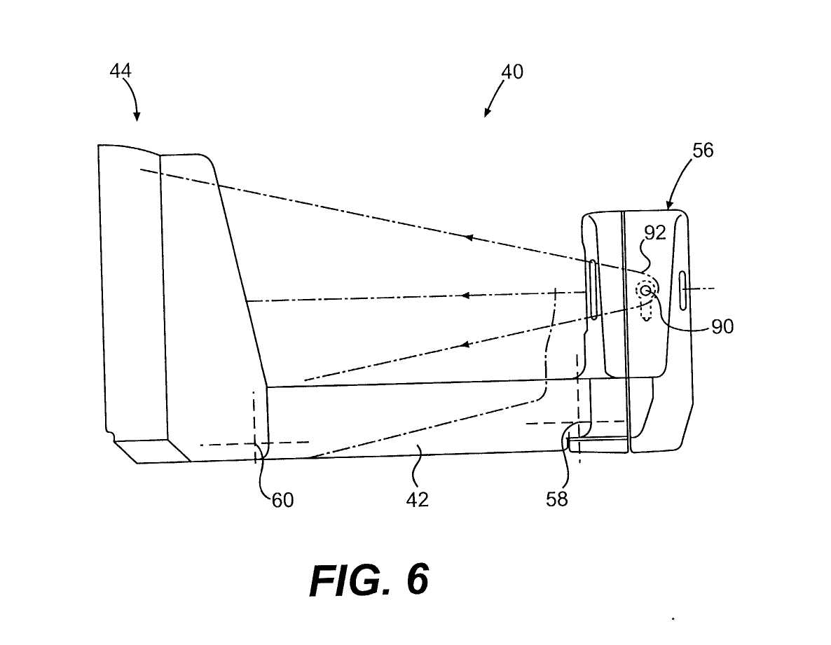

A light source may be positioned within viewer 40 to illuminate stereo photograph 14. In the exemplary embodiment illustrated in FIGS. 5 and 6, a pair of light sources 90, 92 are disposed in housing 56. One light source 90 is positioned to illuminate left image 16. The other light source 92 is positioned to illuminate right image 18.

Housing 56 may also include reflectors 94, 96. Reflector 94 is disposed around light source 90 to direct the generated light rays at left image 16. Similarly, reflector 96 is disposed around light source 92 to direct the generated light rays at right image 18.

Housing 56 may also include baffles 91, 93. Baffle 91 is disposed in housing 56 to prevent light from light source 90 from crossing over and illuminating right image 18. Similarly, baffle 93 is disposed in housing 56 to prevent light from light source 92 from crossing over and illuminating left image 18.

In the exemplary embodiment, baffles 91, 93 and reflectors 94, 96 will direct the light rays generated by light sources 90, 92 to be substantially parallel to a centerline 100 of viewer 40. Because print holder 44 holds stereo photograph 18 in either a curved shape or at an angle relative to centerline 100, the light rays generated by light sources 90, 92 will strike the surface of the stereo photograph 18 at an angle relative to the viewing path. Thus, the light generated by light sources 90, 92 will not be reflected back into the user's eyes 36, 38. This will also prevent glares and/or hot spots from interfering with the user's viewing of the three-dimensional image. The present invention contemplates that additional baffles may be disposed within the viewer to prevent light from shining on other surfaces which may cause glare and/or direct light on the print.

As will be apparent from the foregoing description, the present invention provides a compact three-dimensional image viewer that is capable of securely holding 3D photographs of various sizes. The viewer of the present invention transposes the dual images of a stereo photograph so that there is no need to physically separate the dual images.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A three-dimensional (3D) image viewer, comprising:
a base;
a print holder attached to the base and configured to hold a print containing a right image and a left image;
a housing disposed on the base and including a right viewing port and a left viewing port; and
a beam-splitter disposed on the base between the print holder and the right and left viewing ports, the beam-splitter configured to project a representation of the right image in the left viewing port and a representation of the left image in the right viewing port.

2. The 3D image viewer of claim 1, wherein the beam-splitter includes a right set of mirrors configured to project the representation of the left image in the right viewing port and a left set of mirrors configured to project the representation of the right image in the left viewing port.

3. The 3D image viewer of claim 2, wherein one of the right and left sets of mirrors is configured to project said representation of the left or the right image at an angle relative to the projection of the other of the right and left sets of mirrors.

4. The 3D image viewer of claim 1, wherein the beam splitter is disposed in the housing.

5. The 3D image viewer of claim 1, further comprising a first magnifying lens associated with the right viewing port and a second magnifying lens associated with the left viewing port.

6. The 3D image viewer of claim 1, wherein the print holder has a concave shape.

7. The 3D image viewer of claim 6, wherein the print holder includes at least one slot configured to receive an outer edge of the print.

8. The 3D image viewer of claim 6, wherein the print holder includes a second slot configured to receive an outer edge of a differently sized print.

9. The 3D image viewer of claim 1, wherein the 3D viewer is foldable.

10. The 3D image viewer of claim 9, wherein at least one of the print holder and the beam-splitter housing are pivotally connected to the base and are configured to fold by pivoting.

11. The 3D image viewer of claim 1, further comprising at least one light source for illuminating the print.

12. The 3D image viewer of claim 1, further comprising a first light source for illuminating the right image and a second light source for illuminating the left image.

13. The 3D image viewer of claim 12, further comprising a first baffle configured to direct light from the first light source towards the right image and a second baffle configured to direct light from the second light source towards the left image.

14. The 3D image viewer of claim 13, wherein the base has a centerline, the first baffle directing the light from the first light source in a direction substantially parallel to the centerline of the base and the second baffle directing the light from the second light source in a direction substantially parallel to the centerline of the base.

15. A three-dimensional (3D) image viewer comprising:
a base;
an LCD screen display attached to the base, the LCD screen display operable to display a right image of a subject and left image of the subject;
a housing disposed on the base and including a right viewing port and a left viewing port; and
a beam-splitter disposed on the base between the print holder and the right and left viewing ports, the beam-splitter configured to project a representation of the right image in the left viewing port and a representation of the left image in the right viewing port.

16. The 3D image viewer of claim 15, wherein the beam-splitter includes a right set of mirrors configured to project the representation of the left image in the right viewing port and a left set of mirrors configured to project the representation of the right image in the left viewing port.

17. The 3D image viewer of claim 16, wherein one of the right and left sets of mirrors is configured to project said representation of the left or the right image at an angle relative to the projection of the other of the right and left sets of mirrors.

18. The 3D image viewer of claim 15, wherein the beam splitter is disposed in the housing.

19. The 3D image viewer of claim 15, further comprising a first magnifying lens associated with the right viewing port and a second magnifying lens associated with the left viewing port.

20. The 3D image viewer of claim 15, wherein the 3D viewer is foldable.

21. The 3D image viewer of claim 20, wherein at least one of the LCD screen and the beam-splitter housing are pivotally connected to the base and are configured to fold by pivoting.

22. A method of viewing a three-dimensional (3D) photographic print, comprising:
providing a 3D photographic print having a right two-dimensional image of a subject and a left two-dimensional image of the subject;
projecting a representation of the left two-dimensional image through a right viewing port; and
projecting a representation of the right two-dimensional image through a left viewing port.

23. The method of claim 22, wherein the representation of the left two-dimensional image is projected at an angle relative to the projection of the right two-dimensional image.

24. The method of claim 23, wherein the angle is converging.

25. The method of claim 22, further comprising the step of illuminating the left two-dimensional image and the right two-dimensional image.

26. The method of claim 22, further comprising the step of magnifying the left two-dimensional image and the right two-dimensional image.

27. A three-dimensional (3D) image viewer, comprising:
a base;
a housing disposed on the base and including a right viewing port and a left viewing port; and
a print holder attached to the base and configured to hold a print containing a right image and a left image such that one of the left and right images is viewable through the right viewing port and the other of the left and right images is viewable through the left viewing port, wherein the print holder includes a first trackway configured to receive a first side of the print adjacent the right image and a second trackway configured to receive a second side of the print adjacent to the left image.

28. The 3D viewer of claim 27, further comprising a beam-splitter disposed on the base between the print holder and the right and left viewing ports, the beam-splitter configured to project a representation of the right image in the left viewing port and a representation of the left image in the right viewing port.

29. The 3D image viewer of claim 27, wherein the print holder has a concave shape.

30. The 3D image viewer of claim 27, wherein the print holder includes a third trackway and a fourth trackway configured to receive and hold a differently sized print therebetween.
